(19) United States
(12) Patent Application Publication
(10) Pub. No.: US 2023/0322079 A1
(43) Pub. Date: Oct. 12, 2023

(54) VEHICLE CABIN UNIT AND VEHICLE

(71) Applicant: Atlas Technologies Holding B.V., Helmond (NL)

(72) Inventors: Alex DE RUITER, Amsterdam (NL); Bart Willem GEERS, 's-Hertogenbosch (NL); Koenraad Michaël VAN HAM, Eindhoven (NL)

(21) Appl. No.: 18/017,576

(22) PCT Filed: Jul. 26, 2021
(86) PCT No.: PCT/EP2021/070890

§ 371 Date: Jan. 23, 2023

(30) Foreign Application Priority Data
Jul. 27, 2020 (NL) 2026146

(51) Int. Cl. B60K 35/00

(52) U.S. Cl. CPC B60K 35/00; B60K 2370/1438; B60K 2370/1468; B60K 2370/158; B60K 2370/332; B60K 2370/67

(57) ABSTRACT

The invention pertains to a vehicle cabin unit, which comprises: - a main body, - a panel, which is permanently connected to the main body, which panel has a front surface and a free panel wall, which free panel wall protrudes from or is spaced apart from the main body, wherein the panel comprises a display, which forms at least a part of the front surface of the panel, which display is connectable to a vehicle subsystem controller, wherein the free panel wall of the panel includes a touch sensitive input surface which is configured to allow interaction of a user with the vehicle subsystem controller.

The invention pertains to a vehicle cabin unit and to a vehicle comprising a vehicle cabin unit.

The project leading to this application has received funding from the European Union’s Horizon 2020 research and innovation program under grant agreement No. 848620.

A vehicle cabin unit is for example a dashboard, a part of a dashboard, a central console, a part of a central console, an interior door panel, a part of an interior door panel, a vehicle cabin ceiling or a part of a vehicle cabin ceiling, or any other part that is present in the interior of a passenger cabin of a vehicle and comprises or is suitable to comprise an interface for interacting with one or more functional subsystems of the vehicle.

More and more, physical push buttons with switches in vehicles such as cars and trucks are replaced by touch sensitive input devices such a s touch screen displays and/or touch pads. These devices detect a gesture that is made on at least a part of their outer surface. Such a gesture is then used as input for a functional subsystem of the vehicle, to which functional subsystem the touch sensitive input device is connected.

Touch sensitive input devices are also used as input devices for functional subsystems that are to be controlled by the driver of the vehicle, such as a navigation system, an audio system, a climate control system, an entertainment system, infotainment system, a vehicle information system or vehicle control system. A problem with this transition to touch sensitive input device is that the driver of the vehicle cannot easily feel or otherwise perceive the exact location of the touch sensitive input device where the gesture is to be made. Also, it is not easy to reach out to exactly the correct location on the touch sensitive input device without looking at the touch sensitive input device. In general, it is hard for a driver of a vehicle to correctly and effectively operate a touch sensitive input device in the vehicle without taking his or her eyes from the road.

From document US2019/0193644A1, a vehicle display is known, which vehicle display is moveable between a lower position and an upper position. The orientation of the vehicle display may be different in the lower position and the upper position. When the vehicle comprising the known vehicle display is driven autonomously, the driver may operate push buttons to change the position of the vehicle display between the lower position and the upper position. When the vehicle comprising the known vehicle display is driven manually, the vehicle display is locked in the lower position. As such, the known vehicle display may prevent the field of view of the driver from being reduced by the vehicle display. However, to operate the vehicle display in the lower position, it is necessary for the driver of the vehicle to divert his or her attention to the vehicle display. The known vehicle display does not provide any means for the driver to correctly and effectively operate the vehicle display without taking his or her eyes from the road.

It is the object of the invention to provide a vehicle cabin unit which comprises a touch sensitive input device which can be safely operated by the driver of the vehicle during driving.

The object of the invention is obtained by a vehicle cabin unit, which comprises:
a main body,
a panel, which is permanently connected to the main body, which panel has a front surface and a free panel wall, which free panel wall protrudes from or is spaced apart from the main body,
wherein the panel comprises a display, which forms at least a part of the front surface of the panel,
which display is connectable to a vehicle subsystem controller,
wherein the free panel wall of the panel includes a touch sensitive input surface which is configured to allow interaction of a user with the vehicle subsystem controller.

The vehicle cabin unit according to the invention is for example a dashboard, a part of a dashboard, a central console, a part of a central console, an interior door panel, a part of an interior door panel, a vehicle cabin ceiling or a part of a vehicle cabin ceiling, or any other part that is present in the interior of a passenger cabin of a vehicle and comprises or is suitable to comprise an interface for interacting with one or more functional subsystems of the vehicle into which the vehicle cabin unit is mounted or to be mounted.

The vehicle cabin unit comprises a main body. A panel is permanently connected to the main body. The panel is arranged in and/or attached to the main body during the manufacturing of the vehicle cabin unit and/or the vehicle. Optionally, the display is added to the panel when the vehicle cabin unit is mounted into the vehicle. The panel forms part of the vehicle cabin unit and is not for example a releasable unit that is added onto the main body later, e.g. by the user of the vehicle himself. The panel is for example integrated in the main body, and/or is permanently mounted on a rigid or movable arm, which arm forms part of the main body. Preferably, the panel cannot be removed from the main body without damaging the panel and/or the main body.

Optionally, the panel has a fixed position in the main body of the vehicle cabin unit. Optionally, both the position and the orientation of the panel are fixed in the main body. Alternatively, the panel is tiltable around one or more axes in order to allow the driver to adjust the panel’s orientation, e.g. for better visibility or to reduce glare. In this alternative, the position of the panel relative to the main body remains the same and is therefore fixed, but the panel’s orientation relative to the main body is adjustable. In another alternative, both the orientation and the position of the panel relative to the main body are adjustable.

The panel has a front surface and a free panel wall. The free panel wall protrudes from the main body, or is spaced apart from the main body.

The panel comprises a display. The display forms at least a part of the front surface of the panel. Optionally, the position and orientation of the display is fixed within the panel. Alternatively, the position of the display in the panel is fixed, but the orientation of the display within the panel is adjustable by the display being tiltable around at least one axis relative to the panel.

The display is connectable to a vehicle subsystem controller. The vehicle subsystem controller is adapted to control at least one functional subsystem of the vehicle, e.g. a navigation system, an audio system, a climate control system, an entertainment system, infotainment system, a vehicle information system or a vehicle control system. The vehicle subsystem controller may be a centralised controller which controls multiple functional subsystems from a single control unit, or the vehicle subsystem controller may be designed as a decentralised system, with separate control units for each functional subsystem, the separate control units being distributed over the vehicle.

The connection between the display and the vehicle subsystem controller may be a wired connection or a wireless connection. The connection may be a one-way connection, in which data from the vehicle subsystem controller is transmitted to the display, so the display provides output of the functional subsystem to the driver and/or to a passenger of the vehicle, e.g. information about the status of a functional subsystem. Alternatively, the connection may be a two-way connection, in which data from the vehicle subsystem controller is transmitted to the display as well as data being transmitted from the display to the vehicle subsystem controller. In this case, the display provides output of the vehicle subsystem controller to the driver and/or to a passenger of the vehicle (e.g. information about the status of a functional subsystem), and the driver and/or a passenger can use the display to provide input to the same or a different functional subsystem (e.g. to change a setting of a functional subsystem) via the vehicle subsystem controller. The display is for example a touch screen display when a two-way connection between the display and the vehicle subsystem controller is provided.

In accordance with the invention, the free panel wall of the panel includes a touch sensitive input surface which is configured to allow interaction of the user with the vehicle subsystem controller.

The touch sensitive input surface is or comprises for example a touch screen display and/or a touch pad. The touch sensitive input surface is configured to detect a gesture that is made on at least a part of the touch sensitive input surface. Such a gesture can then be used as input for a vehicle subsystem controller to which the touch sensitive input surface is connected. This makes a touch sensitive input surface different from a push button, which does not detect a gesture of someone or something touching it. A push button is adapted to operate a switch after a certain displacement of an operating surface. Although a touch sensitive input surface may be moveable, this is in general not required for its functioning.

Optionally, the touch sensitive input surface has a fixed position in the free panel wall. Optionally, the touch sensitive input surface has a fixed position in the free panel wall in a direction perpendicular to the free panel wall.

Optionally, the touch sensitive input surface forms part of a touch sensitive input device. Optionally, the vehicle subsystem controller comprises an input port and the touch sensitive input device comprises an output port, and the input port of the vehicle subsystem controller and the output port of the touch sensitive input device are connected to each other via a wired or wireless connection.

Optionally, the touch sensitive input surface is connected to the vehicle subsystem controller by the same connection and/or the same connector that connects the display to the vehicle subsystem controller. Alternatively or in addition, the touch sensitive input surface is connected to the vehicle subsystem controller by a different connection and/or a different connector than the one that connects the display to the vehicle subsystem controller.

Optionally, the touch sensitive input surface is connected to the vehicle subsystem controller via the touch sensitive input device of which the touch sensitive input surface forms a part by the same connection and/or the same connector that connects the display to the vehicle subsystem controller. Alternatively or in addition, the touch sensitive input surface is connected via the touch sensitive input device of which the touch sensitive input surface forms a part to the vehicle subsystem controller by a different connection and/or a different connector than the one that connects the display to the vehicle subsystem controller.

The vehicle cabin unit according to the invention allows the driver to provide input to the touch sensitive input surface without taking his or her eyes off the road. Because the touch sensitive input surface is arranged at the free panel wall of the panel, the driver can easily reach out to and/or grab at the free panel wall in order to touch the touch sensitive input surface. The free panel wall provides a physical object that the driver can reach out to, because the free panel wall protrudes from the main body of the vehicle cabin unit or is spaced apart from the main body. The grabbing reflex is a strong reflex in humans, which makes it easy for the driver to locate the free panel wall — and therewith the touch sensitive input surface — and to move his or her hand to the correct position to operate the touch sensitive input surface. Even in embodiments in which the position and/or orientation of the panel is adjustable relative to the main body of the vehicle cabin unit, the panel will be generally in the same position relative to the person operating the touch sensitive input surface (e.g. the driver or a passenger). This further facilitates operating the touch sensitive input surface without looking at the panel.

In accordance with the invention, the display and the touch sensitive input surface are separate entities. Further, the front surface and the free panel wall are separate entities.

In an embodiment of the vehicle cabin unit according to the invention, the vehicle cabin unit according to the invention further comprises a connector which is adapted to connect the vehicle cabin unit to a vehicle subsystem controller. The connector may for example be or comprise a connector which is adapted to establish a wired connection between the vehicle subsystem controller on the one hand and the touch sensitive input device and/or the display of the vehicle cabin unit on the other hand. Alternatively or in addition, the connector may for example be or comprise a connector which is adapted to establish a wireless connection between the vehicle subsystem controller on the one hand and the touch sensitive input device and/or the display of the vehicle cabin unit on the other hand.

The vehicle cabin unit comprising the connector may be any embodiment of the vehicle cabin unit described above or below.

In an embodiment of the vehicle cabin unit according to the invention, the display is a touch screen display, and the touch screen display is configured to allow interaction of a user with the vehicle subsystem controller.

Optionally, in this embodiment, the touch sensitive input surface is configured to allow interaction of the user with the vehicle subsystem controller as an alternative for or in addition to the touch screen display.

For example, the touch screen display may be used to adjust the setting of a functional subsystem, and the touch sensitive input surface in the free panel wall may be used to adjust the same setting of the same functional subsystem.

Alternatively or in addition, the touch screen display may be used to adjust a first setting of a functional subsystem, and the touch sensitive input surface in the free panel wall may be used to adjust a second setting of the same functional subsystem.

Alternatively or in addition, the touch screen display may be used to adjust a setting of a first functional subsystem, and the touch sensitive input surface in the free panel wall may be used to adjust a setting of a second functional subsystem.

In an embodiment of the vehicle cabin unit according to the invention, the touch sensitive input surface is or comprises a touch pad device which is configured to receive input through a gesture. Alternatively or in addition, the touch sensitive input surface is or comprises a secondary touch screen display which is configured to receive input through a gesture.

Optionally, the touch sensitive input surface is a pressure sensitive touch sensitive input surface. Optionally, the touch sensitive input surface comprises a touch sensitive input area.

In case the touch sensitive input surface is or comprises a secondary touch screen display, the secondary touch screen is present in addition to the display, which display optionally is a touch screen display.

The touch pad or secondary touch screen display optionally comprises a capacitive screen or capacitive surface.

The gesture is for example a single or double tap, and/or a movement over the touch sensitive input surface with one or more fingers or input devices such as a pen which is suitable for interacting with a capacitive surface. The gesture may be at least partly defined by the pressure that is exerted on the touch sensitive input surface.

Optionally, the touch sensitive input surface has a fixed position in the free panel wall. Optionally, the touch sensitive input surface has a fixed position in the free panel wall in a direction perpendicular to the free panel wall.

In an embodiment of the vehicle cabin unit according to the invention, the free panel wall of the panel extends at an angle relative to the front surface of the panel, which angle is optionally between 40° and 140°.

For example, the free panel wall extends perpendicular to the front surface of the panel.

In an embodiment of the vehicle cabin unit according to the invention, the main body of the vehicle cabin unit has a main body surface, and the free panel wall protrudes from the main body surface.

In an embodiment of the vehicle cabin unit according to the invention, the main body of the vehicle cabin unit further comprises an arm, which arm has a free end. In this embodiment, the panel is permanently connected to the free end of the arm.

Optionally, the arm is a rigid arm, in which the free end and a second, opposite end of the arm have a fixed position and fixed orientation relative to each other. Optionally, the main body has a main body surface and the second end is connected to the main body surface —either in a fixed position and fixed orientation, a fixed position and an adjustable orientation, an adjustable position and a fixed orientation or an adjustable position and an adjustable orientation.

Alternatively, the arm is a flexible arm, in which the free end and a second, opposite end of the arm are moveable relative to each other. The flexible arm is for example bendable (e.g. a hinge is provided in the arm), extendable and/or rotatable. Optionally, the main body has a main body surface and the second end is connected to the main body surface - either in a fixed position and fixed orientation, a fixed position and an adjustable orientation, an adjustable position and a fixed orientation or an adjustable position and an adjustable orientation.

In an embodiment of the vehicle cabin unit according to the invention, the free panel wall is at least a part of a circumferential wall of the panel.

For example, the free panel wall is at least a part of a side wall of the panel.

For example, the free panel wall is at least a part of a top wall of the panel.

For example, the free panel wall is at least a part of a bottom wall of the panel.

For example, the free panel wall is at least a part of a side wall of the panel and at least a part of the top wall of the panel.

For example, the free panel wall is at least a part of a side wall of the panel and at least a part of the bottom wall of the panel.

In an embodiment of the vehicle cabin unit according to the invention, the free panel wall is arranged at a distance from the front surface of the panel, and optionally extends substantially parallel to the front surface of the panel.

Optionally, the free panel wall is at least a part of a rear wall of the panel.

In an embodiment of the vehicle cabin unit according to the invention, the vehicle cabin unit further comprises a sensory feedback device which is connected to the touch sensitive input surface of the free panel wall and configured to provide sensory feedback to a user when the user touches the touch sensitive input surface.

The sensory feedback device is or comprises for example a haptic feedback device, a visual feedback device and/or an auditive feedback device.

Optionally, in this embodiment, if the sensory feedback device is or comprises a haptic feedback device, the haptic feedback device comprises a vibrator device which is configured to provide haptic feedback in the form of vibration to at least a part of the touch sensitive input surface. Optionally, the vibrator device is configured to provide a vibration to the touch sensitive input surface of which a frequency and/or amplitude varies depending on the location at which the user touches the touch sensitive input surface and/or on a gesture made by the user. Optionally, the vibrator device comprises a vibration motor and/or a piezoelectric device to generate vibration.

Optionally, the haptic feedback device is configured to provide haptic feedback to the touch sensitive input surface such that the user perceives the presence of a button and/or a slider.

Optionally, if the sensory feedback device is or comprises a visual feedback device, the visual feedback device is configured to provide visual feedback in the form of a visual signal and/or visual representation. For example, the visual feedback device may be provided with one or more light sources such as LEDs, which are arranged at the panel and flare up or change colour when the user touches, e.g. makes a gesture or otherwise activates and/or provides input to the touch sensitive input surface. Alternatively or in addition, the visual feedback device may be configured to provide visual output to the touch sensitive input surface (e.g. when the touch sensitive input device is or comprises a secondary touch screen display) and/or to the display, e.g. in the form of a number, a graph, a triangle which indicates for example the set level of a parameter, and/or a symbol.

Optionally, if the sensory feedback device is or comprises an auditive feedback device, the auditive feedback device is configured to provide audible feedback in the form of an audible signal, e.g. when the user touches, e.g. makes a gesture or otherwise activates and/or provides input to the touch sensitive input surface and/or to the display if the display is a touch sensitive display.

In an embodiment of the vehicle cabin unit according to the invention, the touch sensitive input surface has an elongated shape.

For example, the touch sensitive input surface has a rectangular shape, which has a length that is at least three times the width of that rectangular shape.

The invention further pertains to a vehicle, comprising:
a vehicle subsystem controller, and
a vehicle cabin unit, which comprises:
a main body,
a panel, which is permanently connected to the main body, which panel has a front surface and a free panel wall, which free panel wall protrudes from or is spaced apart from the main body,
wherein the panel comprises a display, which forms at least a part of the front surface of the panel,
which display is connected to the vehicle subsystem controller,
wherein the free panel wall of the panel includes a touch sensitive input surface which is configured to allow interaction of a user with the vehicle subsystem controller.

The vehicle according to the invention is for example a car e.g. a passenger car or light delivery car, a van, a truck, a pick-up truck, a bus, a rail vehicle, a light-rail vehicle or a train. Optionally, the vehicle is an electrical vehicle, for example an electric vehicle which is at least partly chargeable by an on board solar panel.

The vehicle cabin unit in the vehicle according to the invention is for example a dashboard, a part of a dashboard, a central console, a part of a central console, an interior door panel, a part of an interior door panel, a vehicle cabin ceiling or a part of a vehicle cabin ceiling, or any other part that is present in the interior of a passenger cabin of a vehicle and comprises or is suitable to comprise an interface for interacting with one or more functional subsystems of the vehicle into which the vehicle cabin unit is mounted or to be mounted.

The vehicle cabin unit comprises a main body. A panel is permanently connected to the main body. The panel is arranged in and/or attached to the main body during the manufacturing of the vehicle cabin unit and/or the vehicle. Optionally, the display is added to the panel when the vehicle cabin unit is mounted into the vehicle. The panel forms part of the vehicle cabin unit and is not for example a releasable unit that is added onto the main body later, e.g. by the user of the vehicle himself. The panel is for example integrated in the main body, and/or is permanently mounted on a rigid or movable arm which arm forms part of the main body. Preferably, the panel cannot be removed from the main body without damaging the panel and/or the main body.

Optionally, the panel has a fixed position in the main body of the vehicle cabin unit. Optionally, both the position and the orientation of the panel are fixed in the main body. Alternatively, the panel is tiltable around one or more axes in order to allow the driver to adjust the panel’s orientation, e.g. for better visibility or to reduce glare. In this alternative, the position of the panel relative to the main body remains the same and is therefore fixed, but the panel’s orientation relative to the main body is adjustable. In another alternative, both the orientation and the position of the panel relative to the main body are adjustable

The panel has a front surface and a free panel wall. The free panel wall protrudes from the main body or is spaced apart from the main body.

The panel comprises a display. The display forms at least a part of the front surface of the panel. Optionally, the position and orientation of the display is fixed within the panel. Alternatively, the position of the display in the panel is fixed, but the orientation of the display within the panel is adjustable by the display being tiltable around at least one axis relative to the panel.

The display is connected to a vehicle subsystem controller which is present in the vehicle according to the invention. The vehicle subsystem controller is adapted to control at least one functional subsystem of the vehicle, e.g. a navigation system, an audio system, a climate control system, an entertainment system, infotainment system, a vehicle information system or a vehicle control system. The vehicle subsystem controller may be a centralised controller which controls multiple functional subsystems from a single control unit, or the vehicle subsystem controller may be designed as a decentralised system, with separate control units for each functional subsystem, the separate control units being distributed over the vehicle.

The connection between the display and the vehicle subsystem controller may be a wired connection or a wireless connection. The connection may be a one-way connection, in which data from the vehicle subsystem controller is transmitted to the display, so the display provides output of the functional subsystem to the driver and/or to a passenger of the vehicle, e.g. information about the status of a functional subsystem. Alternatively, the connection may be a two-way connection, in which data from the vehicle subsystem controller is transmitted to the display as well as data being transmitted from the display to the vehicle subsystem controller. In this case, the display provides output of the vehicle subsystem controller to the driver and/or to a passenger of the vehicle (e.g. information about the status of a functional subsystem), and the driver and/or a passenger can use the display to provide input to the same or a different functional subsystem (e.g. to change a setting of a functional subsystem) via the vehicle subsystem controller. The display is for example a touch screen display when a two-way connection between the display and the vehicle subsystem controller is provided.

Optionally, the vehicle subsystem controller comprises an output port and the display comprises an input port, and the output port of the vehicle subsystem controller and the input port of the display are connected to each other via a wired or wireless connection.

Optionally, the vehicle subsystem controller comprises an input port and the display comprises an output port, and the input port of the vehicle subsystem controller and the output port of the display are connected to each other via a wired or wireless connection.

In accordance with the invention, the free panel wall of the panel includes a touch sensitive input surface which is configured to allow interaction of the user with the vehicle subsystem controller.

The touch sensitive input surface is or comprises for example a touch screen display and/or a touch pad. The touch sensitive input surface is configured to detect a gesture that is made on at least a part of the touch sensitive input surface. Such a gesture can then be used as input for a vehicle subsystem controller to which the touch sensitive input surface is connected. This makes a touch sensitive input surface different from a push button, which does not detect a gesture of someone or something touching it. A push button is adapted to operate a switch after a certain displacement of an operating surface. Although a touch sensitive input surface may be moveable, this is in general not required for its functioning.

Optionally, the touch sensitive input surface has a fixed position in the free panel wall. Optionally, the touch sensitive input surface has a fixed position in the free panel wall in a direction perpendicular to the free panel wall.

Optionally, the touch sensitive input surface forms part of a touch sensitive input device. Optionally, the functional subsystem comprises an input port and the touch sensitive input device comprises an output port, and the input port of the functional subsystem and the output port of the touch sensitive input device are connected to each other via a wired or wireless connection.

Optionally, the touch sensitive input surface is connected to the vehicle subsystem controller by the same connection and/or the same connector that connects the display to the vehicle subsystem controller. Alternatively or in addition, the touch sensitive input surface is connected to the vehicle subsystem controller by a different connection and/or a different connector than the one that connects the display to the vehicle subsystem controller.

Optionally, the touch sensitive input surface is connected to the vehicle subsystem controller via the touch sensitive input device of which the touch sensitive input surface forms a part by the same connection and/or the same connector that connects the display to the vehicle subsystem controller. Alternatively or in addition, the touch sensitive input surface is connected via the touch sensitive input device of which the touch sensitive input surface forms a part to the vehicle subsystem controller by a different connection and/or a different connector than the one that connects the display to the vehicle subsystem controller.

In an embodiment of the vehicle according to the invention, the vehicle further comprises a first functional subsystem, and the vehicle subsystem controller comprises a first functional controller which is configured to control the first functional subsystem.

The first functional subsystem is for example a navigation system, an audio system, a climate control system, an entertainment system, infotainment system, a vehicle information system or a vehicle control system.

Optionally, the display is a touch screen display, and input to the first functional subsystem can be given via the vehicle subsystem controller through both the touch screen display and the touch sensitive input surface. For example, the touch sensitive input surface allows to set a first parameter for the first functional subsystem and the touch screen display allows to set a second parameter for the first functional subsystem. Alternatively or in addition, the touch screen display and the touch sensitive input surface allow to set the same parameter of the first functional subsystem.

In an embodiment of the vehicle according to the invention, the vehicle comprises a first functional subsystem, and the vehicle subsystem controller comprises a first functional controller which is configured to control the first functional subsystem. Furthermore, the vehicle further comprises a second functional subsystem, and the vehicle subsystem controller comprises a second functional controller which is configured to control the second functional subsystem.

Optionally, in this embodiment the first functional subsystem is one of a navigation system, an audio system, a climate control system, an entertainment system, infotainment system, a vehicle information system or a vehicle control system, and the second functional subsystem is different one of a navigation system, an audio system, a climate control system, an entertainment system, infotainment system, a vehicle information system or vehicle control system.

Optionally, when the display is a touch screen display, the touch sensitive input surface allows to set a parameter of the first functional subsystem and the display allows to set a parameter of the second functional subsystem.

In an embodiment of the vehicle according to the invention, the vehicle further comprises a driver’s seat, which driver’s seat has a back rest which has a driving position, wherein the smallest distance between the back rest in the driving position and the touch sensitive input surface is 90 centimeter or less. This allows the driver to easily access the touch sensitive input surface from the driver’s seat.

In an embodiment of the vehicle according to the invention, the vehicle further comprises a passenger’s seat, which passenger’s seat has a back rest which has a seating position, wherein the smallest distance between the back rest in the seating position and the touch sensitive input surface is 90 centimeter or less.

In an embodiment of the vehicle according to the invention, the vehicle cabin unit further comprises a connector which is adapted to connect the vehicle cabin unit to the vehicle subsystem controller. The connector may for example be or comprise a connector which is adapted to establish a wired connection between the vehicle subsystem controller on the one hand and the touch sensitive input device and/or the display of the vehicle cabin unit on the other hand. Alternatively or in addition, the connector may for example be or comprise a connector which is adapted to establish a wireless connection between the vehicle subsystem controller on the one hand and the touch sensitive input device and/or the display of the vehicle cabin unit on the other hand.

The vehicle cabin unit comprising the connector may be any embodiment of the vehicle cabin unit described above or below.

In an embodiment of the vehicle according to the invention, the display of the vehicle cabin unit is a touch screen display, and the touch screen display is configured to allow interaction of a user with the vehicle subsystem controller.

Optionally, in this embodiment, the touch sensitive input surface is configured to allow interaction of the user with the vehicle subsystem controller as an alternative for or in addition to the touch screen display.

For example, the touch screen display may be used to adjust the setting of a functional subsystem, and the touch sensitive input surface in the free panel wall may be used to adjust the same setting of the same functional subsystem.

Alternatively or in addition, the touch screen display may be used to adjust a first setting of a functional subsystem, and the touch sensitive input surface in the free panel wall may be used to adjust a second setting of the same functional subsystem.

Alternatively or in addition, the touch screen display may be used to adjust a setting of a first functional subsystem, and the touch sensitive input surface in the free panel wall may be used to adjust a setting of a second functional subsystem.

In an embodiment of the vehicle according to the invention, the touch sensitive input surface of the vehicle cabin unit is or comprises a touch pad device which is configured to receive input through a gesture. Alternatively or in addition, the touch sensitive input surface is or comprises a secondary touch screen display which is configured to receive input through a gesture.

Optionally, the touch sensitive input surface is a pressure sensitive touch sensitive input surface. Optionally, the touch sensitive input surface comprises a touch sensitive input area.

In case the touch sensitive input surface is or comprises a secondary touch screen display, the secondary touch screen is present in addition to the display, which display optionally is a touch screen display.

The touch pad or secondary touch screen display optionally comprises a capacitive screen or capacitive surface.

The gesture is for example a single or double tap, and/or a movement over the touch sensitive input surface with one or more fingers or input devices such as a pen which is suitable for interacting with a capacitive surface. The gesture may be at least partly defined by the pressure that is exerted on the touch sensitive input surface.

Optionally, the touch sensitive input surface has a fixed position in the free panel wall. Optionally, the touch sensitive input surface has a fixed position in the free panel wall in a direction perpendicular to the free panel wall.

In an embodiment of the vehicle according to the invention, the free panel wall of the panel of the vehicle cabin unit extends at an angle relative to the front surface of the panel, which angle is optionally between 40° and 140°.

For example, the free panel wall extends perpendicular to the front surface of the panel.

In an embodiment of the vehicle cabin unit according to the invention, the main body of the vehicle cabin unit has a main body surface, and the free panel wall protrudes from the main body surface.

In an embodiment of the vehicle cabin unit according to the invention, the main body of the vehicle cabin unit further comprises an arm, which arm has a free end. In this embodiment, the panel is permanently connected to the free end of the arm.

Optionally, the arm is a rigid arm, in which the free end and a second, opposite end of the arm have a fixed position and fixed orientation relative to each other. Optionally, the main body has a main body surface and the second end is connected to the main body surface -either in a fixed position and fixed orientation, a fixed position and an adjustable orientation, an adjustable position and a fixed orientation or an adjustable position and an adjustable orientation.

Alternatively, the arm is a flexible arm, in which the free end and a second, opposite end of the arm are moveable relative to each other. The flexible arm is for example bendable (e.g. a hinge is provided in the arm), extendable and/or rotatable. Optionally, the main body has a main body surface and the second end is connected to the main body surface - either in a fixed position and fixed orientation, a fixed position and an adjustable orientation, an adjustable position and a fixed orientation or an adjustable position and an adjustable orientation.

In an embodiment of the vehicle according to the invention, the free panel wall of the vehicle cabin unit is at least a part of a circumferential wall of the panel.

For example, the free panel wall is at least a part of a side wall of the panel.

For example, the free panel wall is at least a part of a top wall of the panel.

For example, the free panel wall is at least a part of a bottom wall of the panel.

For example, the free panel wall is at least a part of a side wall of the panel and at least a part of the top wall of the panel.

For example, the free panel wall is at least a part of a side wall of the panel and at least a part of the bottom wall of the panel.

In an embodiment of the vehicle according to the invention, the free panel wall of the vehicle cabin unit is arranged at a distance from the front surface of the panel, and optionally extends substantially parallel to the front surface of the panel.

Optionally, the free panel wall is at least a part of a rear wall of the panel.

In an embodiment of the vehicle according to the invention, the vehicle cabin unit of the vehicle further comprises a sensory feedback device which is connected to the touch sensitive input surface of the free panel wall and configured to provide sensory feedback to a user when the user touches the touch sensitive input surface.

The sensory feedback device is or comprises for example a haptic feedback device, a visual feedback device and/or an auditive feedback device.

Optionally, in this embodiment, if the sensory feedback device is or comprises a haptic feedback device, the haptic feedback device comprises a vibrator device which is configured to provide haptic feedback in the form of vibration to at least a part of the touch sensitive input surface. Optionally, the vibrator device is configured to provide a vibration to the touch sensitive input surface of which a frequency and/or amplitude varies depending on the location at which the user touches the touch sensitive input surface and/or on a gesture made by the user. Optionally, the vibrator device comprises a vibration motor and/or a piezoelectric device to generate vibration.

Optionally, the haptic feedback device is configured to provide haptic feedback to the touch sensitive input surface such that the user perceives the presence of a button and/or a slider.

Optionally, if the sensory feedback device is or comprises a visual feedback device, the visual feedback device is configured to provide visual feedback in the form of a visual signal and/or visual representation. For example, the visual feedback device may be provided with one or more light sources such as LEDs, which are arranged at the panel and flare up or change colour when the user touches, e.g. makes a gesture or otherwise activates and/or provides input to the touch sensitive input surface. Alternatively or in addition, the visual feedback device may be configured to provide visual output to the touch sensitive input surface (e.g. when the touch sensitive input device is or comprises a secondary touch screen display) and/or to the display, e.g. in the form of a number, a graph, a triangle which indicates for example the set level of a parameter, and/or a symbol.

Optionally, if the sensory feedback device is or comprises a auditive feedback device, the auditive feedback device is configured to provide audible feedback in the form of an audible signal, e.g. when the user touches, e.g. makes a gesture or otherwise activates and/or provides input to the touch sensitive input surface and/or to the display if the display is a touch sensitive display.

In an embodiment of the vehicle according to the invention, the touch sensitive input surface of the vehicle cabin unit has an elongated shape.

For example, the touch sensitive input surface has a rectangular shape, which has a length that is at least three times the width of that rectangular shape.

The invention will be described in more detail below under reference to the drawing, in which in a non-limiting manner exemplary embodiments of the invention will be shown. The drawing shows in:

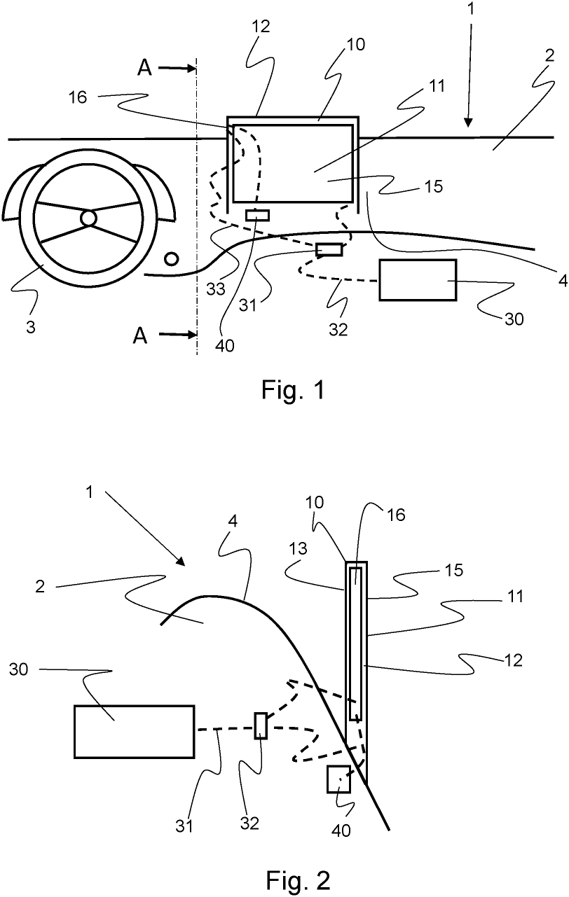

FIG. 1: schematically, a first embodiment of a vehicle cabin unit according to the invention, in front view,

FIG. 2: schematically, the embodiment of FIG. 1, in side view, seen from line A-A in FIG. 1,

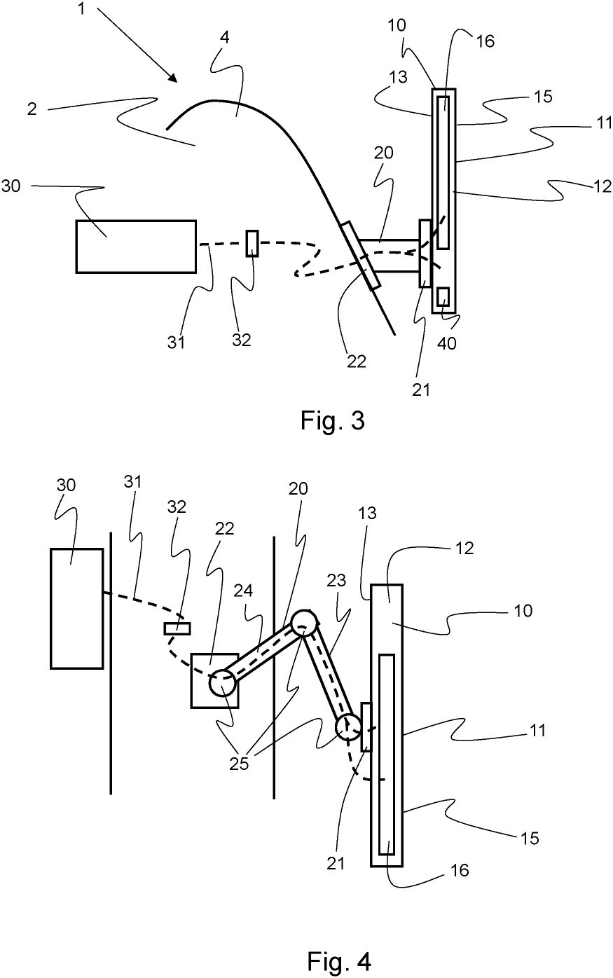

FIG. 3: schematically, a first variant of the embodiment of FIG. 1 of a vehicle cabin unit according to the invention, in side view,

FIG. 4: schematically, a second variant of the embodiment of FIG. 1 of a vehicle cabin unit according to the invention, in top view,

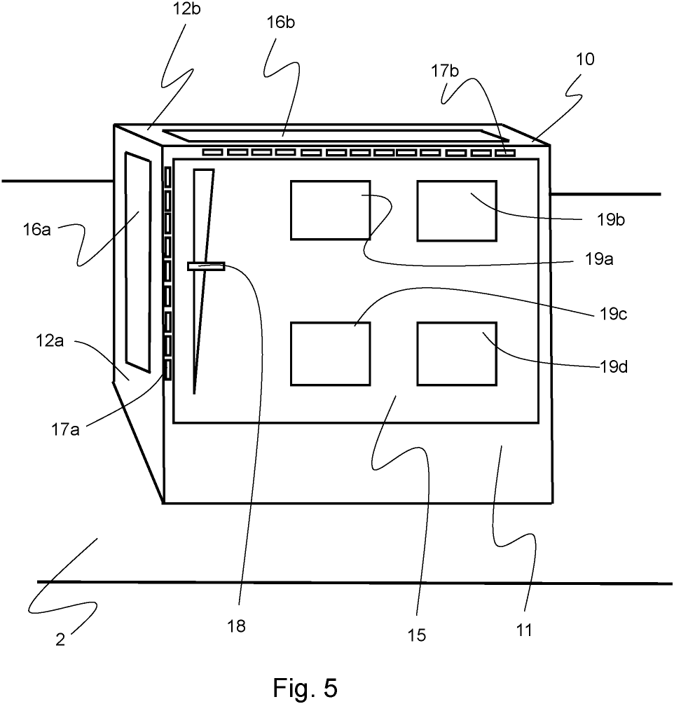

FIG. 5: schematically, a detail of an example of a panel with a display and a touch sensitive input surface according to the invention.

FIG. 1 shows, schematically, a first embodiment of a vehicle cabin unit 1 according to the invention, in front view. In the embodiment of FIG. 1, the vehicle cabin unit 1 is connected to a vehicle subsystem controller 30. FIG. 2 shows, schematically, the embodiment of FIG. 1 in side view, seen from line A-A in FIG. 1.

In the embodiment of FIG. 1 and FIG. 2, the vehicle cabin unit 1 is a dashboard of a car, mounted behind and to the left of steering wheel 3.

The vehicle cabin unit 1 comprises a main body 2. A panel 10 is permanently connected to the main body 2. In the embodiment of FIG. 1 and FIG. 2, the panel 10 cannot be removed from the main body 2 without damaging the panel 10 and/or the main body 2. In the embodiment of FIG. 1, the panel 10 is integrated in the main body 2.

In the embodiment of FIG. 1, the panel 10 has a fixed position in the main body 2 of the vehicle cabin unit 1. Optionally, the panel 2 is tiltable around one or more axes in order to allow the driver to adjust the panel’s orientation, e.g. for better visibility or to reduce glare. The panel has a front surface 11 and a free panel wall 12. The free panel wall 12 protrudes from the main body 2. In the embodiment of FIG. 1 and FIG. 2, the free panel wall 12 includes the top wall and both side walls of the panel 10.

The panel 10 comprises a display 15. The display 15 forms at least a part of the front surface 11 of the panel 12. Optionally, the position and orientation of the display 15 is fixed within the panel 10. Alternatively, the position of the display 15 in the panel is fixed, but the orientation of the display 15 within the panel 10 is adjustable by the display 15 being tiltable around at least one axis relative to the panel 10.

The display 15 is connectable to a vehicle subsystem controller 30 via connector 31. The connector 31 establishes a connection 32 between the display 15 and the vehicle subsystem controller 30. The vehicle subsystem controller 30 is adapted to control at least one functional subsystem of the vehicle, e.g. a navigation system, an audio system, a climate control system, an entertainment system, infotainment system, a vehicle information system or a vehicle control system.

In the embodiment of FIG. 1 and FIG. 2, the vehicle subsystem controller is a centralised controller which controls multiple functional subsystems of the vehicle from a single control unit. Alternatively, the vehicle subsystem controller can be designed as a decentralised system, which separate control units for each functional subsystem, the control units being distributed over the vehicle.

The connection 32 between the display 15 and the vehicle subsystem controller 30 may be a wired connection or a wireless connection. The connection 32 may be a one-way connection, in which data from the vehicle subsystem controller 30 is transmitted to the display 15, so the display 15 provides output of the functional subsystem to the driver and/or to a passenger of the vehicle, e.g. information about the status of a functional subsystem. Alternatively, the connection 32 may be a two-way connection, in which data from the vehicle subsystem controller 30 is transmitted to the display 15 as well as data being transmitted from the display 15 to the vehicle subsystem controller 30. In this case, the display 15 provides output of the vehicle subsystem controller 30 to the driver and/or to a passenger of the vehicle (e.g. information about the status of a functional subsystem), and the driver and/or a passenger can use the display 15 to provide input to the same or a different functional subsystem (e.g. to change a setting of a functional subsystem) via the vehicle subsystem controller 30. The display 15 is for example a touch screen display when a two-way connection between the display 15 and the functional subsystem controller 30 is provided.

In the embodiment of FIG. 1 and FIG. 2, the free panel wall 12 of the panel 10 includes a touch sensitive input surface 16 which is configured to allow interaction of the user with the vehicle subsystem controller 30. In the embodiment of FIG. 1 and FIG. 2, the touch sensitive input surface 16 is located on the left side wall of the panel 10.

In the embodiment of FIG. 1 and FIG. 2, the touch sensitive input surface has an elongated shape, in particular a rectangular shape.

The touch sensitive input surface 16 is or comprises for example a touch screen display and/or a touch pad. The touch sensitive input surface 16 is configured to detect a gesture that is made on at least a part of the touch sensitive input surface. Such a gesture can then be used as input for a vehicle subsystem controller 30 to which the touch sensitive input surface is connected.

In the embodiment of FIG. 1, the touch sensitive input surface 16 has a fixed position in the free panel wall 12. In particular, the touch sensitive input surface 16 has a fixed position in the free panel wall 12 in a direction perpendicular to the free panel wall 12.

In the embodiment of FIG. 1 and FIG. 2, the touch sensitive input surface 16 forms part of a touch sensitive input device. Optionally, the vehicle subsystem controller 30 comprises an input port and the touch sensitive input device comprises an output port, and the input port of the vehicle subsystem controller and the output port of the touch sensitive input device are connected to each other via a wired or wireless connection.

In the embodiment of FIG. 1 and FIG. 2, the touch sensitive input surface 16 is connected to the vehicle subsystem controller 30 by connection 33, which connects touch sensitive input surface 16 to the connector 31, which is the same connector that connects the display 15 to the vehicle subsystem controller 30. The connection 33 may be a wired connection or a wireless connection.

In the embodiment of FIG. 1 and FIG. 2, the connector 32 is part of the vehicle cabin unit and is adapted to connect the vehicle cabin unit to the vehicle subsystem controller 30. The connector 32 may for example be or comprise a connector which is adapted to establish a wired connection between the vehicle subsystem controller 30 on the one hand and the touch sensitive input device 16 and the display 15 of the vehicle cabin unit 1 on the other hand. Alternatively or in addition, the connector 32 may for example be or comprise a connector which is adapted to establish a wireless connection between the vehicle subsystem controller 30 on the one hand and the touch sensitive input device 16 and the display 15 of the vehicle cabin unit 1 on the other hand.

In the embodiment of FIG. 1 and FIG. 2, the display 15 is for example a touch screen display, and the touch screen display is configured to allow interaction of a user with the vehicle subsystem controller 30.

The touch sensitive input surface 16 is configured to allow interaction of the user with the vehicle subsystem controller 30 as an alternative for or in addition to the display 15 which is a touch screen display.

For example, the display 15 which is a touch screen display may be used to adjust the setting of a functional subsystem, and the touch sensitive input surface 16 in the free panel wall 12 may be used to adjust the same setting of the same functional subsystem.

Alternatively or in addition, the display 15 which is a touch screen display may be used to adjust a first setting of a functional subsystem, and the touch sensitive input surface 16 in the free panel wall may be used to adjust a second setting of the same functional subsystem.

Alternatively or in addition, the display 15 which is a touch screen display may be used to adjust a setting of a first functional subsystem, and the touch sensitive input surface 16 in the free panel wall may be used to adjust a setting of a second functional subsystem.

In the embodiment of FIG. 1 and FIG. 2, the touch sensitive input surface 16 is or comprises a touch pad device which is configured to receive input through a gesture. Alternatively or in addition, the touch sensitive input surface 16 is or comprises a secondary touch screen display which is configured to receive input through a gesture.

Optionally, the touch sensitive input surface 16 is a pressure sensitive touch sensitive input surface. Optionally, the touch sensitive input surface 16 comprises a touch sensitive input area.

In case the touch sensitive input surface 16 is or comprises a secondary touch screen display, the secondary touch screen is present in addition to the display 15, which display 15 In the embodiment of FIG. 1 and FIG. 2 a touch screen display.

The touch pad or secondary touch screen display optionally comprises a capacitive screen or capacitive surface.

The gesture is for example a single or double tap, and/or a movement over the touch sensitive input surface 16 with one or more fingers or input devices such as a pen which is suitable for interacting with a capacitive surface. The gesture may be at least partly defined by the pressure that is exerted on the touch sensitive input surface.

In the embodiment of FIG. 1 and FIG. 2, the free panel wall 12 of the panel 10 extends perpendicular to the front surface 11 of the panel 10.

In the embodiment of FIG. 1 and FIG. 2, the main body 2 of the vehicle cabin unit 1 has a main body surface 4, and the free panel wall 12 protrudes from the main body surface 4.

In the embodiment of FIG. 1 and FIG. 2, the lower side of the panel 10 merges with the main body surface 4, while the side walls and rear wall 13 of the panel 10 protrude from the main body surface 4. The top wall is spaced apart from the main body surface 4. The side walls, top wall and rear wall 13 are all free panel walls.

In the embodiment of FIG. 1 and FIG. 2, the vehicle cabin unit further comprises a sensory feedback device 40 which is connected to the touch sensitive input surface 16 of the free panel wall 12 and configured to provide sensory feedback to a user when the user touches the touch sensitive input surface 16.

The sensory feedback device 40 is or comprises for example a haptic feedback device, a visual feedback device and/or an auditive feedback device.

Optionally, in this embodiment, if the sensory feedback device 40 is or comprises a haptic feedback device, the haptic feedback device comprises a vibrator device which is configured to provide haptic feedback in the form of vibration to at least a part of the touch sensitive input surface 16. Optionally, the vibrator device is configured to provide a vibration to the touch sensitive input surface 16 of which a frequency and/or amplitude varies depending on the location at which the user touches the touch sensitive input surface 16 and/or on a gesture made by the user. Optionally, the vibrator device comprises a vibration motor and/or a piezoelectric device to generate vibration.

Optionally, the haptic feedback device is configured to provide haptic feedback to the touch sensitive input surface such that the user perceives the presence of a button and/or a slider.

Optionally, if the sensory feedback device 40 is or comprises a visual feedback device, the visual feedback device is configured to provide visual feedback in the form of a visual signal and/or visual representation. For example, the panel 10 may be provided with one or more light sources such as LEDs, which flare up or change colour when the user touches, e.g. makes a gesture or otherwise activates and/or provides input to the touch sensitive input surface 16. Alternatively or in addition, the visual feedback device may be configured to provide visual output to the touch sensitive input surface 16 (e.g. when the touch sensitive input device is or comprises a secondary touch screen display) and/or to the display, e.g. in the form of a number, a graph, a triangle which indicates for example the set level of a parameter, and/or a symbol.

Optionally, if the sensory feedback device 40 is or comprises an auditive feedback device, the auditive feedback device is configured to provide audible feedback in the form of an audible signal, e.g. when the user touches, e.g. makes a gesture or otherwise activates and/or provides input to the touch sensitive input surface 16 and/or to the display 15 if the display is a touch sensitive display.

Optionally, the vehicle in which the vehicle cabin unit 1 of FIG. 1 and FIG. 2 is mounted or is to be mounted comprises a first functional subsystem, and the vehicle subsystem controller 30 comprises a first functional controller which is configured to control the first functional subsystem.

The first functional subsystem is for example a navigation system, an audio system, a climate control system, an entertainment system, infotainment system, a vehicle information system or a vehicle control system.

The display 15 in this embodiment is a touch screen display, and input to the first functional subsystem can be given via the vehicle subsystem controller 30 through both the display 15 and the touch sensitive input surface 16. For example, the touch sensitive input surface 16 allows to set a first parameter for the first functional subsystem and the display 15 allows to set a second parameter for the first functional subsystem. Alternatively or in addition, the display 15 and the touch sensitive input surface 16 allow to set the same parameter of the first functional subsystem.

Optionally, the vehicle in which the vehicle cabin unit 1 of FIG. 1 and FIG. 2 is mounted or is to be mounted comprises a first functional subsystem, and the vehicle subsystem controller 30 comprises a first functional controller which is configured to control the first functional subsystem. Furthermore, the vehicle further comprises a second functional subsystem, and the vehicle subsystem controller 30 comprises a second functional controller which is configured to control the second functional subsystem.

Optionally, in this embodiment the first functional subsystem is one of a navigation system, an audio system, a climate control system, an entertainment system, infotainment system, a vehicle information system or a vehicle control system, and the second functional subsystem is different one of a navigation system, an audio system, a climate control system, an entertainment system, infotainment system, a vehicle information system or vehicle control system.

Optionally, the touch sensitive input surface 16 allows to set a parameter of the first functional subsystem and the display 15 allows to set a parameter of the second functional subsystem.

FIG. 3 shows, schematically, a first variant of the embodiment of FIG. 1 of a vehicle cabin unit according to the invention, in side view.

The main difference between the embodiment of FIG. 1 and FIG. 2 on the one hand and FIG. 3 on the other hand is in the way the panel 10 is mounted onto the main body 2. While in the embodiment of FIG. 1 and FIG. 2, the panel 10 protrudes from the main body surface 4 of the main body 2, in FIG. 3, the panel 10 is mounted on an arm 20 of the main body 2.

The arm 20 has a free end 21. The panel 10 is permanently connected to the free end 21 of the arm 2. The panel is arranged in and/or attached to the main body during the manufacturing of the vehicle cabin unit and/or the vehicle. Optionally, the display is added to the panel when the vehicle cabin unit is mounted into the vehicle. Preferably, the panel 10 cannot be removed from the arm 20 of the main body 2 without damaging the panel 10 and/or the main body 2.

In the embodiment of FIG. 3, the arm 20 is a rigid arm. The free end 21 and a second, opposite end 22 of the arm 20 have a fixed position and fixed orientation relative to each other.

In the embodiment of FIG. 3, the main body 2 has a main body surface 4 and the second end 22 is connected to the main body surface 4. In this embodiment, the second end 22 of the arm 20 is connected to the main body surface 4 in a fixed position and fixed orientation. Alternatively, the second end 22 of the arm 20 may be connected to the main body surface 4 in a fixed position and an adjustable orientation, an adjustable position and a fixed orientation or an adjustable position and an adjustable orientation.

The arm 20 as shown in FIG. 3, and the alternative embodiments described thereof, can be used in combination with all embodiments of the vehicle cabin unit described above and below.

The embodiment of FIG. 3 also is slightly different from the embodiment of FIG. 1 and FIG. 2 in that the sensory feedback device 40 is arranged in the panel 10 instead of in or behind the main body 2. The positioning of the sensory feedback device 40 will generally be determined by practical considerations, e.g. where there is sufficient space in the lay-out and/or the type and location of the sensory feedback to be provided.

In the embodiment of FIG. 3, the side walls, top wall and lower wall of the panel 10 are spaced apart from the main body 2. As the rear wall 13 of the panel 10 is connected to the arm 20, and the arm forms part of the main body 2, the rear wall 13 can be considered to protrude from the main body 2. So, in the embodiment of FIG. 3, the panel comprises multiple free panel walls 12. The free panel walls are the side walls, top wall, lower wall and rear wall 13 of the panel 10.

In the embodiment of FIG. 3, an elongated, rectangular touch sensitive input surface 16 is present on a side wall of the panel 10. Alternatively or in addition, a touch sensitive input surface 16 may be present for example on the top wall and/or on the rear wall of the panel 10.

FIG. 4 shows, schematically, a second variant of the embodiment of FIG. 1 of a vehicle cabin unit according to the invention, in top view.

Like in the embodiment of FIG. 3, in the embodiment of FIG. 4, the panel 10 is mounted on an arm 20. However, in the embodiment of FIG. 4, the arm 20 is a flexible arm, while in the embodiment of FIG. 3, the arm 20 is a rigid arm.

Like in the variant of FIG. 3, the arm 20 of the variant of FIG. 4 comprises a free end 21 to which the panel 10 is permanently fixed. The second, opposite end 22 is permanently fixed to the main body 2.

In the variant of FIG. 4, the free end 21 and the second, opposite end of the arm are moveable relative to each other 22, in the example of FIG. 4, the second end 22 being fixed and the free end 21 being moveable.

In the particular example of FIG. 4, the flexible arm 20 FIG. 4 is articulated, comprising a first arm part 23 and a second arm part 24. Three hinges 25 are provided: one between free end 21 and the first arm part 23, one between the first arm part 23 and the second arm part 24 and one between the second arm part 24 and the second end 22.

The flexible arm 20 of FIG. 4 allows the position and optionally also the orientation of the panel to be adjusted to the user’s preferences.

FIG. 5 shows, schematically, a detail of an example of a panel 10 with a display 15 and a touch sensitive input surface 16 according to the invention.

The panel 10 in the example of FIG. 5 is protrudes from the main body 2 of the vehicle cabin unit in a similar way as the embodiment of FIG. 1 and FIG. 2. However, a panel 10 according to FIG. 5 can also be mounted on an arm 20 as is for example shown in FIG. 3 and FIG. 4.

The panel 10 has a front surface 11. A display 15 is provided, which forms at least a part of the front surface 11 of the panel 10. In the example of FIG. 5, the display 15 is a touch screen display, which allows to provide input to a functional subsystem of a vehicle in which the vehicle cabin unit is mounted. A vehicle subsystem controller 30 is connected to the display 15 and receives the input the user provides to the touch screen display. In the example of FIG. 5, the display 15 displays several areas 19a, 19b, 19c, 19d, which act as virtual buttons, and a slide 18. When the user touches one of the areas 19a, 19b, 19c, 19d, he may for example enter a submenu. By putting a finger on the slider 18 and sliding the finger up or down over the display 15, the user may change a parameter setting of a functional subsystem of the vehicle.

In the example of FIG. 5, the side walls and the top wall are free panel walls 12a, 12b. A side wall is provided with a first touch sensitive input surface 16a, and the top surface is provided with a second touch sensitive input surface 16b. The free panel walls 12a, 12b extend in the example of FIG. 5 at an angle of 90° relative to the front surface 11 of the panel 10.

Optionally, at least one touch sensitive input surface 16a, 16b is a pressure sensitive touch sensitive input surface or comprises a touch sensitive input area.

In the front surface 11 of the panel 10, a first array 17a of LEDs (i.e. light emitting diodes) is provided which extends along the first touch sensitive input surface 16a. In addition, a second array 17b of LEDs is provided which extends along the second touch sensitive input surface 16b.

The arrays 17a, 17b of LEDs provide visual feedback to the user when the user operates the touch sensitive input surface 16a, 16b adjacent the respective array 17a, 17b of LEDs. For example, the LED next to the position of the finger of the user lights up when the user touches, e.g. taps, the touch sensitive input surface 16a, 16b, or when the user slides his finger over the touch sensitive input surface 16a, 16b, the LEDs along the trajectory of the user’s finger over the touch sensitive input surface 16a, 16b light up.

In addition to the visual feedback provided by the arrays or LEDs, haptic and/or auditive feedback may be provided.

Optionally, the vehicle in which the panel 10 of FIG. 5 is mounted or is to be mounted comprises a first functional subsystem, and the vehicle subsystem controller 30 comprises a first functional controller which is configured to control the first functional subsystem.

The first functional subsystem is for example a navigation system, an audio system, a climate control system, an entertainment system, infotainment system, a vehicle information system or a vehicle control system.

Input to the first functional subsystem can be given via the vehicle subsystem controller 30 through both the display 15 and the touch sensitive input surfaces 16a, 16b. For example, the first touch sensitive input surface 16a allows to set a first parameter for the first functional subsystem, the display 15 allows to set a second parameter for the first functional subsystem and the second touch sensitive input surface 16b allows to set a third parameter for the first functional subsystem, Alternatively or in addition, for example the display 15 and the first touch sensitive input surface 16a allow to set the same parameter of the first functional subsystem.

Optionally, the vehicle in which the panel 10 of FIG. 5 is mounted or is to be mounted comprises a first functional subsystem, and the vehicle subsystem controller 30 comprises a first functional controller which is configured to control the first functional subsystem. Furthermore, the vehicle further comprises a second functional subsystem, and the vehicle subsystem controller 30 comprises a second functional controller which is configured to control the second functional subsystem.

Optionally, in this embodiment the first functional subsystem is one of a navigation system, an audio system, a climate control system, an entertainment system, infotainment system, a vehicle information system or a vehicle control system, and the second functional subsystem is different one of a navigation system, an audio system, a climate control system, an entertainment system, infotainment system, a vehicle information system or vehicle control system.

For example, input for the first functional subsystem can be provided via the display 15 and/or the first touch sensitive input surface 16a, and input for the second functional subsystem can be provided via the second touch sensitive input surface 16b.

1. A vehicle cabin unit, which comprises:
a main body,
a panel, which is permanently connected to the main body, which panelhas a front surfaceand a free panel wal, which free panel wallprotrudes from or is spaced apart from the main body,
wherein the panelcomprises a display, which forms at least a part of the front surfaceof the panel,
which displayis connectable to a vehicle subsystem controller,
wherein the free panel wallof the panelincludes a touch sensitive input surfacewhich is configured to allow interaction of a user with the vehicle subsystem controller.

2. The vehicle cabin unitaccording to claim 1, wherein the displayis a touch screen display, and the touch screen display is configured to allow interaction of a user with the vehicle subsystem controller.

3. The vehicle cabin unitaccording to claim 2, wherein the touch sensitive input surfaceis configured to allow interaction of the user with the vehicle subsystem controlleras an alternative for or in addition to the touch screen display.

4. The vehicle cabin unitaccording to claim 1,
wherein the touch sensitive input surfaceis or comprises a touch pad device which is configured to receive input through a gesture and/or a secondary touch screen display which is configured to receive input through a gesture.

5. The vehicle cabin unitaccording to claim 1,
wherein the free panel wallof the panelextends at an angle relative to the front surfaceof the panel, which angle is optionally between 40° and 140°.

6. The vehicle cabin unitaccording to claim 1,
wherein the free panel wallis at least a part of a circumferential wall of the panel.

7. The vehicle cabin unit claim 1,
wherein the free panel wallis arranged at a distance from the front surfaceof the panel, and optionally extends substantially parallel to the front surfaceof the panel.

8. The vehicle cabin unitaccording to claim 7,
wherein the free panel wallis at least a part of a rear wall of the panel.

9. The vehicle cabin unit according to claim 1,
wherein the vehicle cabin unitfurther comprises a sensory feedback device which is connected to the touch sensitive input surfaceof the free panel walland configured to provide sensory feedback to a user when the user touches the touch sensitive input surface.

10. The vehicle cabin unitaccording to claim 9,
wherein the sensory feedback deviceis or comprises a haptic feedback device, a visual feedback device and/or an auditive feedback device.

11. The vehicle cabin unitaccording to claim 10,
wherein a haptic feedback device of the sensory feedback device comprises a vibrator device which is configured to provide haptic feedback in the form of vibration to at least a part of the touch sensitive input surface,
and wherein optionally the vibrator device is configured to provide a vibration to the touch sensitive input surfaceof which a frequency and/or amplitude varies depending on the location at which the user touches the touch sensitive input surface and/or on a gesture made by the user.

12. The vehicle cabin unitaccording to to claim 10,
wherein a haptic feedback device of the sensory feedback deviceis configured to provide haptic feedback to the touch sensitive input surface such that the user perceives the presence of a button and/or a slider.

13. The vehicle cabin unitaccording to claim 10,
wherein a visual feedback device of the sensory feedback deviceis configured to provide visual feedback in the form of a visual signal and/or visual representation,
and wherein the visual feedback device is optionally be provided with one or more light sources such as LEDs which are arranged at the panel.

14. The vehicle cabin unit according to claim 1,
wherein the touch sensitive input surfacehas an elongated shape.

15. A vehicle, comprising:
a vehicle subsystem controller, and
a vehicle cabin unit, which comprises:
a main body,
a panel, which is permanently connected to the main body, which panelhas a front surfaceand a free panel wall, which free panel wallprotrudes from or is spaced apart from the main body,
wherein the panelcomprises a display, which forms at least a part of the front surfaceof the panel,
which displayis connected to the vehicle subsystem controller,
wherein the free panel wallof the panel includes a touch sensitive input surfacewhich is configured to allow interaction of a user with the vehicle subsystem controller.

16. The vehicle according to claim 15,
wherein the vehicle further comprises a first functional subsystem, and wherein the vehicle subsystem controller comprises a first functional controller which is configured to control the first functional subsystem.

17. The vehicle according to claim 16,
wherein the vehicle further comprises a second functional subsystem, and wherein the vehicle subsystem controllercomprises a second functional controller which is configured to control the second functional subsystem.

18. The vehicle according to claim 15,
wherein the first functional subsystem is a navigation system, an audio system, a climate control system, an entertainment system, infotainment system, a vehicle information system or a vehicle control system.

19. The vehicle according to claim 16,
wherein the first functional subsystem is one of a navigation system, an audio system, a climate control system, an entertainment system, infotainment system, a vehicle information system or a vehicle control system, and
wherein the second functional subsystem is different one of a navigation system, an audio system, a climate control system, an entertainment system, infotainment system, a vehicle information system or vehicle control system.

20. The vehicle according to claim 15,
wherein the vehicle further comprises a driver’s seat, which driver’s seat has a back rest which has a driving position, wherein the smallest distance between the back rest in the driving position and the touch sensitive input surfaceis 90 centimeter or less.
